(19) United States
(12) Patent Application Publication
(10) Pub. No.: US 2026/0177370 A1
(43) Pub. Date: Jun. 25, 2026

(54) ROTATION ANGLE DETECTION DEVICE AND FOLDABLE MACHINE COMPRISING SAME

(71) Applicant: TDK CORPORATION, Tokyo (JP)

(72) Inventors: Kentaro HARADA, Tokyo (JP); Shuaicheng WANG, Tokyo (JP)

(73) Assignee: TDK CORPORATION, Tokyo (JP)

(21) Appl. No.: 19/403,406

(22) Filed: Nov. 28, 2025

(30) Foreign Application Priority Data
Dec. 19, 2024 (JP) 2024-224128

(51) Int. Cl. G01B 7/30; G01D 5/16; G06F 1/16

(52) U.S. Cl. CPC G01B 7/30; G01D 5/16; G06F 1/1616

(57) ABSTRACT

A rotation angle detection device comprises a magnet attached to one of a first member and a second member that is rotatably supported by the first member, and a magnetic sensor attached to the other of the first member and the second member. The first member has a first rotation axis extending in the Z-direction, and the second member has a second rotation axis that is parallel to the first rotation axis. The second member rotates about the first rotation axis in a first angle interval and rotates about the second rotation axis in a second angle interval that is contiguous with the first angle interval. The magnetic sensor detects the direction of the magnetic field in a plane orthogonal to the Z-direction. The magnetic sensor is spaced away from the center of the magnet in the Z-direction.

### FIELD

This application claims the benefit of Japanese Priority Patent Application No. 2024-224128 filed on Dec. 19, 2024, the entire contents of which are incorporated herein by reference.

This disclosure relates to a rotation angle detection device and a foldable machine comprising same.

### BACKGROUND

In recent years, personal computers (hereafter referred to as “PCs”) sometimes have a mechanism that allows a display unit to rotate 360° relative to the PC body. U.S. Patent Publication No. 2023/0033055A describes a PC comprising gravity sensors attached in each of the display unit and the PC body whereby the rotation angle of the display unit relative to the PC body can be determined from the outputs of the two gravity sensors.

### SUMMARY

The object of the present disclosure is to provide a rotation angle detection device that is mounted in a foldable machine comprising a first member and a second member rotatably supported by the first member and that is capable of detecting the rotation angle of the second member regardless of the orientation of the foldable machine.

The rotation angle detection device of the present disclosure comprises: a magnet attached to one of a first member and a second member that is rotatably supported by the first member; and a magnetic sensor attached to the other of the first member and the second member. The first member has a first rotation axis extending in a first direction, the second member has a second rotation axis that is parallel to the first rotation axis, and the second member rotates about the first rotation axis in a first angle interval and rotates about the second rotation axis in a second angle interval that is contiguous with the first angle interval. The magnetic sensor detects the direction of the magnetic field in a plane orthogonal to the first direction. The magnetic sensor is spaced away from the center of the magnet in the first direction.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a side view of a PC (foldable machine) according to a first example embodiment of the technology.

FIG. 2 is a schematic view showing the states of rotation of a display unit and a magnetic sensor in the first example embodiment of the technology.

FIGS. 3A to 3C are schematic configuration views of a rotation angle detection device according to the first example embodiment of the technology.

FIGS. 4A to 4B are schematic views showing the relationship between the rotation angle of a display unit and the magnetic field, and further, showing the relationship between the rotation angle of the display unit and the direction of the magnetic field in the first example embodiment of the technology.

FIG. 5 is a top view of a magnet and the magnetic sensor.

FIG. 6 is a schematic view of the rotation of the display unit and the magnet in a second example embodiment of the technology.

FIGS. 7A to 7B are schematic views showing the relationship between the rotation angle of the display unit and the magnetic field, and further, showing the relationship between the rotation angle of the display unit and the direction of the magnetic field in the second example embodiment of the technology.

FIGS. 8A to 8B are schematic views showing the relationship between the rotation angle of the display unit and the magnetic field, and further, showing the relationship between the rotation angle of the display unit and the direction of the magnetic field in a third example embodiment of the technology.

FIG. 9 is a schematic configuration view of an angle sensor.

FIGS. 10A to 10F are schematic configuration views showing variations of the rotation angle detection device.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

A gravity sensor such as that in U.S. Patent Publication No. 2023/0033055A may not function accurately depending on the orientation of a PC. For example, when a display unit is rotated while the rotation axis of the display unit to the PC body is oriented in the vertical direction, the rotation angle cannot be detected because the gravitational force does not change. A similar problem exists in a foldable machine that comprises a first member and a second member that is rotatably supported by the first member.

Example embodiments of the present disclosure will be explained with reference to the drawings. In the following description and drawings, the first direction is the direction in which first and second rotation axes 6 and 7 extend and is referred to as the Z-direction. Because magnet 21 and magnetic sensor 31 move relative to each other, a coordinate system is defined for each of magnet 21 and magnetic sensor 31. In the coordinate system of magnet 21, the two directions orthogonal to the Z-direction and orthogonal to each other are referred to as the MX-direction and MY-direction. In the coordinate system of magnetic sensor 31, the two directions orthogonal to the Z-direction and orthogonal to each other are referred to as the SX-direction and SY-direction. The Z-direction (Z-axis) is common to the two coordinate systems. Therefore, the coordinate system of magnet 21 is the MX-MY-Z coordinate system and the coordinate system of magnetic sensor 31 is the SX-SY-Z coordinate system.

### First Example Embodiment

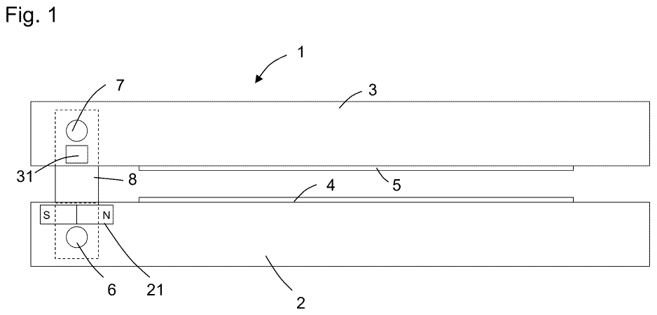

FIG. 1 is a side view of personal computer (PC) 1 according to the first example embodiment of the present disclosure. PC 1 may comprise PC body 2 (an example of the first member) having operation unit 4 such as a keyboard, and a display unit 3 (an example of the second member) having a display panel 5. Display panel 5 may be an organic EL panel, a liquid crystal panel, or the like and may have a touch panel function. Display unit 3 may be rotatably supported by PC body 2. PC body 2 may have first rotation axis 6 extending in the Z-direction, and display unit 3 may have second rotation axis 7 extending in the Z-direction and parallel to first rotation axis 6 (i.e., spaced away from first rotation axis 6). First rotation axis 6 and second rotation axis 7 may be rod-shaped members and may be fixed to PC body 2 and display unit 3, respectively. First rotation axis 6 and second rotation axis 7 may be in the same position when viewed from the direction perpendicular to operation unit 4 of PC body 2. PC 1 may comprise connecting member 8 that connects first rotation axis 6 and second rotation axis 7. PC 1 is an example of a foldable machine of the present disclosure, and the present disclosure is not limited to PC 1.

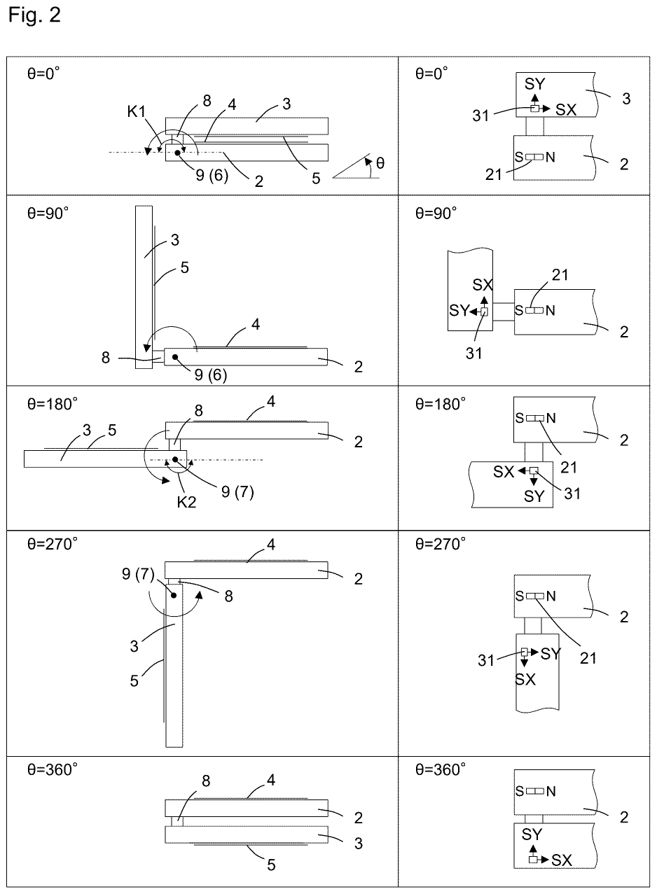

The left side of FIG. 2 shows rotation over 360° of display unit 3 relative to PC body 2. Here, PC body 2 may be fixed with operation unit 4 facing upward and display unit 3 rotating around PC body 2. However, PC body 2 may also rotate, and both display unit 3 and PC body 2 may rotate. The black dots in the drawings indicate rotation center 9 of display unit 3. Rotation center 9 transits during its rotation.

Rotation angle θ of display unit 3 is defined as the direction of opening display unit 3 with the rotation angle of the closed state of display unit 3 being 0°. In the range of 0°≤θ≤180°, display unit 3 may rotate around first rotation axis 6 in first angle interval K1, and PC 1 can be used in the same way as an ordinary laptop. In the range of 180°≤θ≤360°, display unit 3 may rotate around second rotation axis 7 in second angle interval K2. In the 360° rotated state, PC 1 can be used as a tablet. Connecting member 8 may be fixed to PC body 2 and display unit 3 may rotate around connecting member 8. First angle interval K1 and second angle interval K2 may be continuous, each covering an angular range of 180°. PC 1 may have a locking mechanism (not shown) that prevents display unit 3 from rotating around second rotation axis 7 in first angle interval K1 and that prevents display unit 3 from rotating around first rotation axis 6 in second angle interval K2.

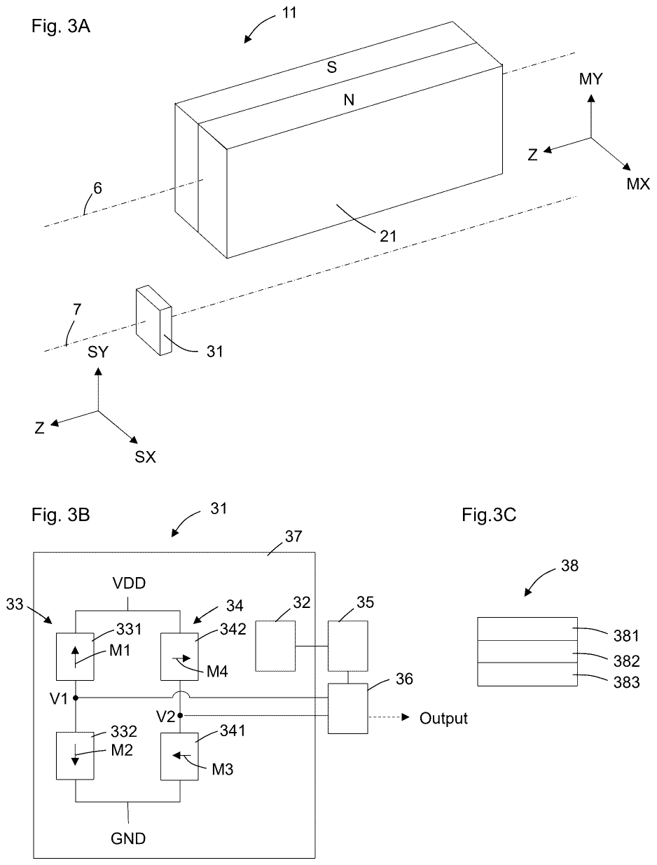

FIG. 3A shows a schematic configuration view of rotation angle detection device 11 and FIG. 3B shows a schematic configuration view of magnetic sensor 31. PC 1 may have rotation angle detection device 11 that detects rotation angle θ of display unit 3. Rotation angle detection device 11 may have magnet 21 and magnetic sensor 31 that detects the direction of the magnetic field generated by magnet 21. Magnet 21 can be attached to one of PC body 2 and display unit 3, and magnetic sensor 31 can be attached to the other of PC body 2 and display unit 3. As shown in FIGS. 1 and 2, magnet 21 in this example embodiment may be attached to PC body 2 and magnetic sensor 31 may be attached to display unit 3. Magnet 21 may be directly attached to first rotation axis 6 but may be attached in the vicinity of first rotation axis 6. Magnetic sensor 31 may be directly attached to second rotation axis 7 but may be attached in the vicinity of second rotation axis 7. Magnet 21 may be a rectangular body having parallel sides in each of the MX-, MY-, and Z-directions, and its dimension in the Z-direction may be greater than its dimensions in the MX- and MY-directions. Magnet 21 may be magnetized in the MX-direction but may be magnetized in the MY-direction.

As shown in FIG. 3B, magnetic sensor 31 may have first magnetic field detection unit 32 that detects magnetic field BZ in the Z-direction, second magnetic field detection unit 33 that detects magnetic field BX in the SX-direction, and third magnetic field detection unit 34 that detects magnetic field BY in the SY-direction. First magnetic field detection unit 32 can be configured as a full bridge and can be provided with a soft magnetic material (yoke) to change the direction of the magnetic field. Second magnetic field detection unit 33 and third magnetic field detection unit 34 may be each configured as a half bridges but can also be configured as full bridges. Second magnetic field detection unit 33 and third magnetic field detection unit 34 may be connected to power supply VDD at one end and grounded (GND) at the other end. Second magnetic field detection unit 33 may have first and second portions 331 and 332 connected in series, and third magnetic field detection unit 34 may have third and fourth portions 341 and 342 connected in series. First magnetic field detection unit 32, first and second portions 331 and 332 of second magnetic field detection unit 33, and third and fourth portions 341 and 342 of third magnetic field detection unit 34 each may have a magnetoresistive element 38 shown in FIG. 3C. Magnetization direction M1 of magnetic pinned layer 383 of first portion 331 and magnetization direction M2 of magnetic pinned layer 383 of second portion 332 may be in opposite directions (may have an angular difference of) 180°, and magnetization direction M3 of magnetic pinned layer 383 of third portion 341 and magnetization direction M4 of magnetic pinned layer 383 of fourth portion 342 may be also in opposite directions (may have an angular difference of) 180°. Magnetization directions M1 and M2 and magnetization directions M3 and M4 may be orthogonal to each other.

FIG. 3C shows a schematic configuration of magnetoresistive element 38. Magnetoresistive element 38 may have magnetic free layer 381 whose magnetization direction changes with respect to an external magnetic field, magnetic pinned layer 383 whose magnetization direction is pinned with respect to an external magnetic field, and nonmagnetic layer 382 located between magnetic free layer 381 and magnetic pinned layer 383. Nonmagnetic layer 382 may be an insulating layer such as MgO or Al₂O₃. Magnetoresistive element 38 may function as a tunnel magnetoresistive element (TMR element). Nonmagnetic layer 382 may comprise a nonmagnetic metal layer such as copper or silver, in which case magnetoresistive element 38 may function as a giant magnetoresistive element (GMR element). TMR elements may tend to provide higher output than GMR elements. First to third magnetic field detection units 32-34 may be formed on a single substrate 37, and substrate 37 may be formed on display unit 3 in a direction parallel to the SX-SY plane. The configurations of first to third magnetic field detection units 32-34 are not limited as long as they can detect magnetic fields, and for example, these units may comprise AMR elements or Hall elements.

The right side of FIG. 2 shows the movement of magnet 21 and magnetic sensor 31 in response to rotation of display unit 3. Since PC body 2 may be fixed in this example embodiment, magnet 21 may maintain the same position and orientation during the rotation of display unit 3. As a result, the magnetic field generated by magnet 21 may also remain unchanged regardless of rotation angle θ of display unit 3. On the other hand, magnetic sensor 31 may be mounted on display unit 3, and magnetic fields BZ, BX, and BY detected by the first to third magnetic field detection units 32 to 34 may therefore be a function of rotation angle θ as described below. Magnetic sensor 31 may rotate around the Z-direction, and the SX-axis and SY-axis may consequently also rotate around the Z-axis.

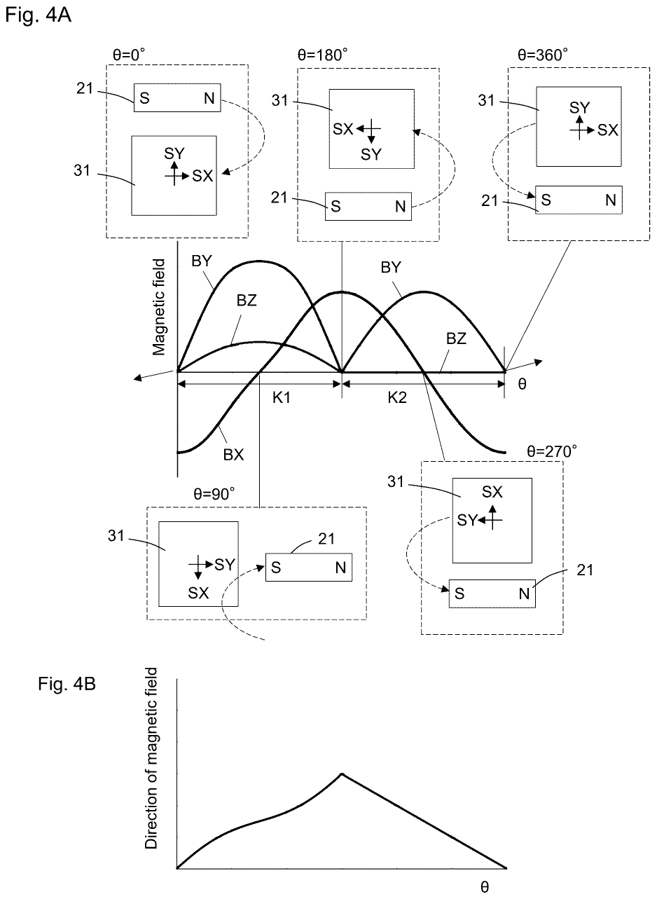

FIG. 4A shows magnetic fields BZ, BX, and BY detected by first to third magnetic field detection units 32-34. The dashed lines in the drawings conceptually show the magnetic flux moving in and out of magnet 21. Magnetic field BX may change sinusoidally as display unit 3 rotates 360°. In contrast, magnetic field BY may change by half a wavelength of the sine wave as display unit 3 rotates 180° in first angle interval K1, and may change by half a wavelength of the sine wave in the same direction as in first angle interval K1 during rotation over 180° in second angle interval K2. This phenomenon may occur because magnetic field BY may be in the same direction at θ=90° and 270° due to the relative positioning of third magnetic field detection unit 34 and magnet 21. At θ=90°, magnetic sensor 31 may face the edge (S-pole) of magnet 21, and at θ=270°, magnetic sensor 31 may face the side of magnet 21, with the result that magnetic field BY in first angle interval K1 may be larger than magnetic field BY in second angle interval K2.

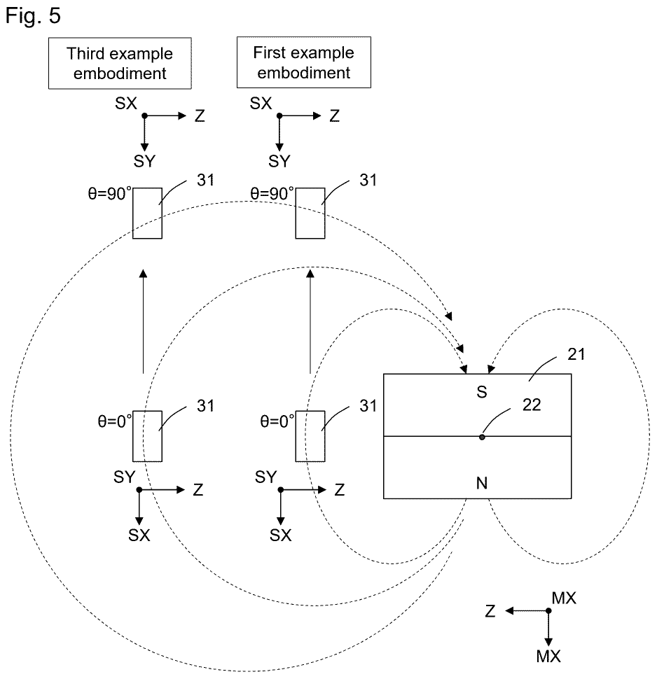

FIG. 5 shows a top view of magnet 21 and magnetic sensor 31 viewed from the MY-direction. The dashed lines in the drawing conceptually show the magnetic flux moving in and out of magnet 21. When θ=0°, magnetic sensor 31 may overlie the symmetry axis (center line) of magnet 21 as viewed from the Z-direction, that is, magnetic sensor 31 may be at the center of magnet 21 in the MX-direction. Therefore, at θ=0° magnetic field BZ may be zero due to the symmetry of the magnetic field. As magnetic sensor 31 may rotate in first angle interval K1, magnetic field BZ may change sinusoidally as magnetic sensor 31 moves from the center of magnet 21 in the MX-direction. When θ=180° (although not shown, this case coincides with the position θ=0° in FIG. 5), magnetic field BZ may again be zero. In second angle interval K2, magnetic field BZ may almost be zero because magnetic sensor 31 may rotate (may turn) about second rotation axis 7 and the magnetic field in the Z-direction may exhibit very little change. As can be seen from FIG. 5, due to the symmetry of the magnetic field at center 22 of magnet 21 in the Z-direction, BZ=0 regardless of rotation angle θ, and rotation angle θ cannot be detected. Therefore, magnetic sensor 31 may be installed away from center 22 of magnet 21 in the Z-direction. However, magnetic sensor 31 may be installed at a position that overlies magnet 21 in the Z-direction or at a position spaced from magnet 21.

As shown in FIG. 3B, magnetic sensor 31 may include determination unit 35 that determines whether display unit 3 is in first angle interval K1 or in second angle interval K2 based on magnetic field BZ. Determination unit 35 may make this determination based on whether magnetic field BZ is greater or smaller than a reference value. If the absolute value of magnetic field BZ is greater than the reference value, determination unit 35 may determine that display unit 3 is in first angle interval K1, and if the absolute value of magnetic field BZ is less than the reference value, determination unit 35 may determine that display unit 3 is in second angle interval K2. The reference value may be zero or may be slightly greater than zero to account for signal errors. In an alternative example embodiment, the determination may take into account the direction of the magnetic field. That is, if the intensity of magnetic field BZ (with a positive or negative sign) is equal to or greater than the reference value, determination unit 35 may determine that display unit 3 is in first angle interval K1. If magnetic field BZ is equal to or smaller than the reference value, determination unit 35 may determine that display unit 3 is in second angle interval K2. Because the alternative example embodiment may take a value other than zero for magnetic field BY in second angle interval K2, magnetic sensor 31 may be off-center in the MX-direction of magnet 21 at θ=0° and 180°. This arrangement increases the degree of freedom in the installation position of the magnetic field sensor.

Magnetic sensor 31 may have calculation unit 36 that detects (calculates) the magnetic field direction (magnetic field angle) in the plane (SX-SY plane) orthogonal to the Z-direction based on magnetic fields BX and BY detected by second and third magnetic field detection units 33 and 34. FIG. 4B shows the magnetic field direction (magnetic field angle) obtained by calculation unit 36. Specifically, calculation unit 36 may calculate rotation angle θ as θ=atan 2 (V2−VDD/2, V1−VDD/2) when display unit 3 is in first angle interval K1. When display unit 3 is in second angle interval K2, rotation angle θ may be θ=−atan 2 (V2−VDD/2, V1−VDD/2). V1 is the voltage between first part 331 and second part 332 and V2 is the voltage between third part 341 and fourth part 342. When the orthogonal coordinate system is (x, y) and the polar coordinate system is (r, θ), atan 2 (y, x) is a function that returns angle θ (where −π<θ≤π, θ=0 coincides with the +x-direction, and angle θ increases counterclockwise), where x=rcos θ and y=rsin θ. If necessary, a correction term may be added to set the initial rotation angle θ to 0° when display unit 3 is closed. When second magnetic field detection unit 33 and third magnetic field detection unit 34 are configured as half bridges, determination unit 35 and calculation unit 36 can be provided outside substrate 37 in the form of a microcomputer or the like.

PC 1 can perform various operations depending on rotation angle θ. For example, when θ=180−360°, PC 1 may be used as a tablet, and the operation of operation unit 4 can therefore be disabled. When θ=0°, display unit 3 may be closed, and PC 1 can therefore be put to sleep or the brightness of display unit 3 can be reduced. Alternatively, the brightness and contrast of display panel 5 of display unit 3 can be adjusted according to rotation angle θ.

Because the relative positional relationship between magnet 21 and magnetic sensor 31 may be invariant in this example embodiment, the magnetic field applied from magnet 21 to magnetic sensor 31 may depend only on rotation angle θ. The magnetic field applied to magnetic sensor 31 may not be affected by the position or orientation of PC 1, and rotation angle θ will therefore not be undetectable due to the position or orientation of PC 1.

Other example embodiments and variations are described below. Configurations and effects that are the same as those of the first example embodiment will be omitted from the explanation.

### Second Example Embodiment

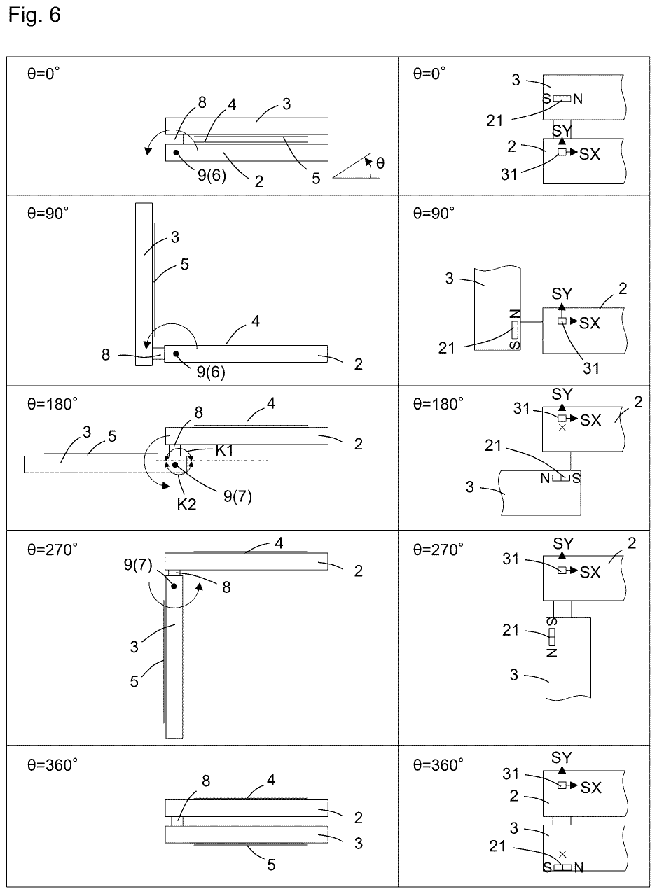

In this example embodiment, magnet 21 may be attached to display unit 3 and magnetic sensor 31 may be attached to PC body 2. Magnetic sensor 31 may be spaced away from center 22 of magnet 21 in the Z-direction. The left side of FIG. 6 shows the rotation of display unit 3 with respect to PC body 2, and the right side shows the movement of magnet 21 and magnetic sensor 31 as display unit 3 rotates. The movement of display unit 3 relative to PC body 2 may be the same as in the first example embodiment. In this example embodiment, the position and orientation of magnetic sensor 31 may be constant, but because magnet 21 may rotate along with the rotation of display unit 3, the magnetic fields detected by first to third magnetic field detection units 32 to 34 may be a function of rotation angle θ.

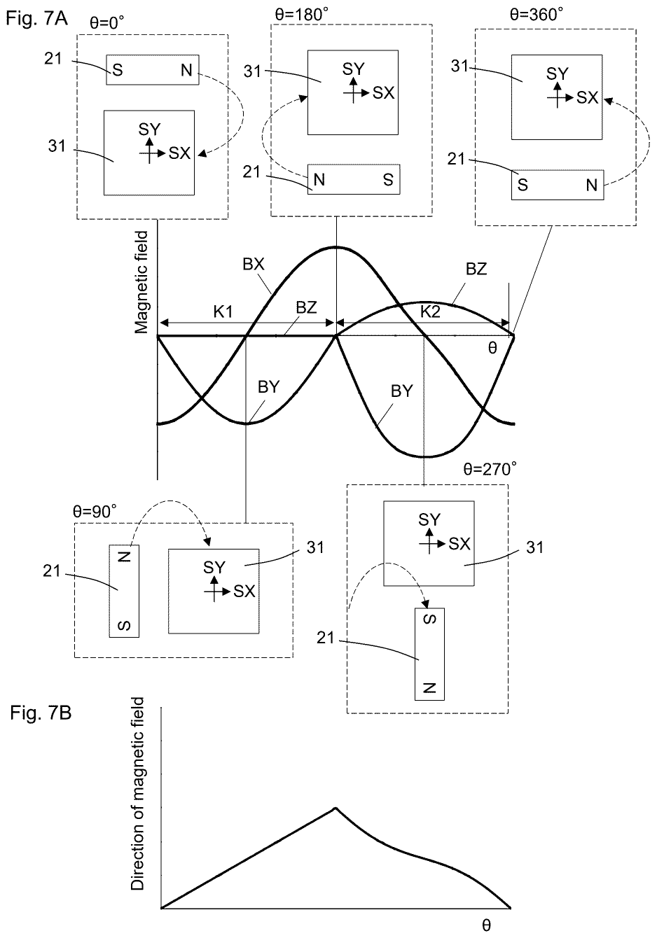

FIG. 7A shows magnetic fields BZ, BX, and BY detected by first to third magnetic field detection units 32-34. Magnetic field BX may exhibit the same changes as in the first example embodiment. The direction of magnetic field BY may be opposite to that of the first example embodiment, but its overall shape may be the same as that of the first example embodiment. Magnetic field BZ may almost be zero in first angle interval K1 and may change sinusoidally in second angle interval K2. Therefore, rotation angle θ of display unit 3 can be detected in this example embodiment as in the first example embodiment.

### Third Example Embodiment

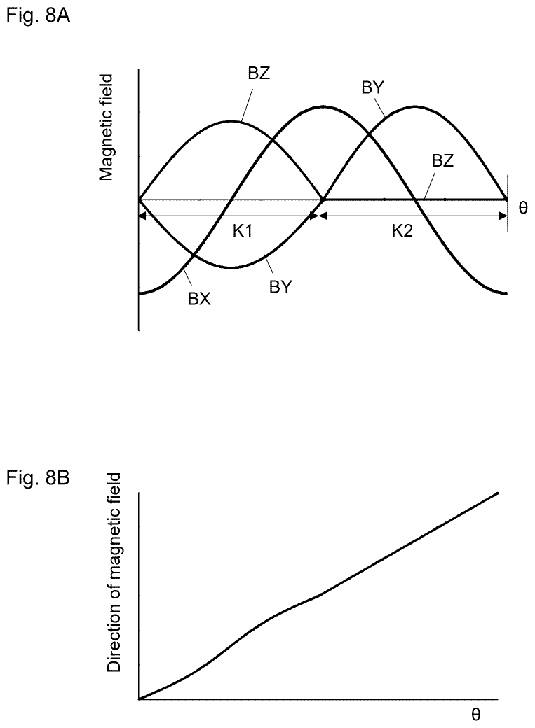

In the third example embodiment, as in the first example embodiment, magnet 21 may be attached to PC body 2 and magnetic sensor 31 may be attached to display unit 3. FIG. 8A shows magnetic fields BZ, BX, and BY detected by first to third magnetic field detection units 32-34. Unlike the first example embodiment, magnetic field BY in this example embodiment may change one sinusoidal cycle during the 360° rotation of display unit 3. In other words, magnetization BY in first angle interval K1 may be in the direction opposite to that of the first example embodiment. A magnetic field of this pattern can be obtained by placing magnetic sensor 31 at a position more distant in the Z-direction from magnet 21 than in the first example embodiment. Referring to FIG. 5, when magnetic sensor 31 is at a position of θ=0°, magnetic fields BX and BY at the position of magnetic sensor 31 may be the same in the first and third example embodiments. However, when magnetic sensor 31 is at the position of θ=90°, magnetic field BY may be in the opposite direction.

Magnetic sensor 31 should therefore be located away from magnet 21 in the Z-direction. As shown in FIG. 8B, rotation angle θ and the direction of the magnetic field may have a linear relationship that corresponds one-to-one over first and second angle intervals K1 and K2, and as a result, magnetic field BY may need not be considered as a separate case. Magnetic sensor 31 of the first example embodiment can also be used in this example embodiment, but neither determination unit 35 nor first magnetic field detection unit 32 may be needed. Although not shown in the drawings, magnet 21 may be attached to display unit 3 and magnetic sensor 31 may be attached to PC body 2. In other words, this example embodiment may be combined with the second example embodiment.

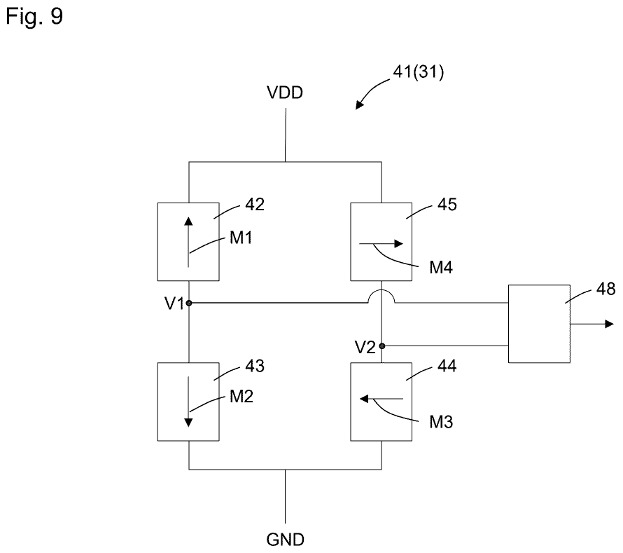

As an alternative configuration, angle sensor 41 shown in FIG. 9 can be used as magnetic sensor 31. Angle sensor 41 may comprise first to fourth magnetic field detection units 42 to 45 connected by bridges. First magnetic field detection unit 42 and second magnetic field detection unit 43 may constitute first pair 46 connected in series, and third magnetic field detection unit 44 and fourth magnetic field detection unit 45 may constitute second pair 47 connected in series. One end of first pair 46 and one end of second pair 47 may be connected to power supply VDD and the other ends may be grounded (GND). First magnetic field detection unit 42 and fourth magnetic field detection unit 45 may be located on the side of power supply VDD, and second magnetic field detection unit 43 and third magnetic field detection unit 44 may be located on the ground side (GND). First to fourth magnetic field detection units 42-45 may be each equipped with magnetoresistive element 38 shown in FIG. 3. Magnetization direction M1 of magnetic pinned layer 383 of first magnetic field detection unit 42 and magnetization direction M2 of magnetic pinned layer 383 of second magnetic field detection unit 43 may be oriented in opposite directions (have an angular difference of) 180°. Magnetization direction M3 of magnetic pinned layer 383 of third magnetic field detection unit 44 and magnetization direction M4 of magnetic pinned layer 383 of fourth magnetic field detection unit 45 may be oriented in opposite directions (may have an angular difference of) 180°. Magnetization directions M1 and M2 and magnetization directions M3 and M4 may be orthogonal to each other. Therefore, first pair 46 detects magnetic field BX (or BY) and second pair 47 may detect magnetic field BY (or BX). Angle sensor 41 may have calculation unit 48 that performs calculations based on output V1 between first magnetic field detection unit 42 and second magnetic field detection unit 43 and output V2 between third magnetic field detection unit 44 and fourth magnetic field detection unit 45. Calculation unit 48 may calculate atan (V2/V1) and outputs rotation angle θ. Thus, angle sensor 41 can detect the direction of the composite magnetic field of the magnetic fields in the two directions in the plane (SX-SY plane) orthogonal to the Z-direction and orthogonal to each other. The configuration of angle sensor 41 can be simplified compared to previously described magnetic sensor 31.

### Variation

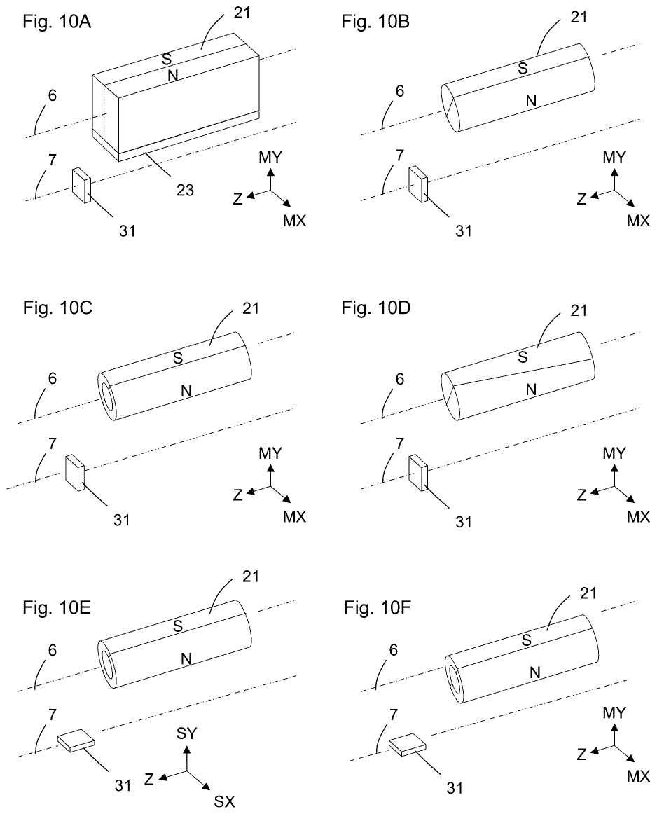

FIGS. 10A to 10F show variations of rotation angle detection device 11. Because rotation angle detection device 11 may be arranged in the limited space between PC body 2 and display unit 3 and the arrangement spaces may have various positions and various shapes, the following variations can be applied to increase the applicability to various PCs 1. As shown in FIG. 10A, rotation angle detection device 11 may have soft magnetic body 23 attached to magnet 21. Soft magnetic body 23 may function as a yoke and strengthens the magnetic field applied to magnetic sensor 31.

As shown in FIG. 10B, magnet 21 may have a solid cylindrical shape. As shown in FIG. 10C, magnet 21 may have a hollow cylindrical shape. In these variations, the magnetization direction of magnet 21 may be oriented in any direction in the MX-MY plane. In these variations, the central axis of magnet 21 can be aligned with first rotation axis 6.

As shown in FIG. 10D, the magnetization direction of magnet 21 may be tilted from the direction perpendicular to the Z-direction, and magnet 21 may be magnetized in any direction different from the Z-direction. When the magnetic sensor is at the center of the magnet in the MX-direction, the magnetic field BX will be zero and the rotation angle θ will be undetectable if magnet 21 is magnetized in the Z-direction.

As shown in FIG. 10E, magnetic sensor 31 may be mounted in the SX-Z plane or in the SY-Z plane, which is not shown. As shown in FIG. 10F, the central axis of magnet 21 may be spaced away from first rotation axis 6 and second rotation axis 7. This variation increases the degree of freedom of the location of magnet 21.

According to the present disclosure, a rotation angle detection device can be provided that is mounted in a foldable machine comprising a first member and a second member rotatably supported by the first member, the rotation angle detection device being capable of detecting the rotation angle of the second member regardless of the orientation of the foldable machine.

Although preferred example embodiments of the present disclosure have been shown and described in detail, it is to be understood that various changes and modifications are possible without departing from the intent or scope of the appended claims.

### REFERENCE NUMERALS

1 personal computer (foldable machine)
2 PC body
3 display unit
6 first rotation axis
7 second rotation axis
11 rotation angle detection device
21 magnet
23 soft magnetic body
31 magnetic sensor
32-34 first to third magnetic field detection units
35 determination unit
36 calculation unit

1. A rotation angle detection device comprising: a magnet attached to one of a first member and a second member rotatably supported by the first member; and a magnetic sensor attached to the other of the first member and the second member, wherein
the first member has a first rotation axis extending in a first direction, the second member has a second rotation axis that is parallel to the first rotation axis, and the second member rotates about the first rotation axis in a first angle interval and rotates about the second rotation axis in a second angle interval that is contiguous with the first angle interval,
the magnetic sensor detects the direction of a magnetic field in a plane orthogonal to the first direction, and
the magnetic sensor is spaced away from the center of the magnet in the first direction.

2. The rotation angle detection device according to claim 1, wherein the first and second angle intervals each cover 180°.

3. The rotation angle detection device according to claim 1, wherein the magnetic sensor comprises:
a first magnetic field detection unit that detects a magnetic field in the first direction; and
a determination unit that makes a determination whether the second member is in the first or second angle interval based on the magnetic field in the first direction.

4. The rotation angle detection device according to claim 3, wherein the determination unit makes the determination based on whether the magnetic field in the first direction is greater than or less than a reference value.

5. The rotation angle detection device according to claim 3, wherein
the magnetic sensor comprises:
second and third magnetic field detection units that detect magnetic fields in two directions that are orthogonal to the first direction and orthogonal to each other; and
a calculation unit that determines the direction of the magnetic field based on the determination of the determination unit and the magnetic fields detected by the second and third magnetic field detection units.

6. The rotation angle detection device according to claim 1, wherein the magnetic sensor detects the direction of a composite magnetic field of the magnetic fields in two directions that are orthogonal to the first direction and orthogonal to each other, and the direction of the composite magnetic field corresponds one-to-one to the rotation angle of the second member over the first and second angle intervals.

7. The rotation angle detection device according to claim 6, wherein the magnetic sensor is located away from the magnet in the first direction.

8. The rotation angle detection device according to claim 1 comprising a soft magnetic material attached to the magnet.

9. The rotation angle detection device according to claim 1, wherein the magnet is magnetized in a direction other than the first direction.

10. The rotation angle detection device according to claim 1, wherein the magnet is attached to the first member and the magnetic sensor is attached to the second member.

11. The rotation angle detection device according to claim 1, wherein the magnet is attached to the second member and the magnetic sensor is attached to the first member.

12. The rotation angle detection device according to claim 1, wherein the magnetic sensor comprises a TMR element.

13. A foldable machine comprising:
a first member;
a second member that is rotatably supported by the first member; and
the rotation angle detection device according to any one of claim 1, wherein
the magnet of the rotation angle detection device is attached to one of the first member and the second member, and the magnetic sensor of the rotation angle detection device is attached to the other of the first member and the second member.

14. The foldable machine according to claim 13, wherein the foldable machine is a personal computer in which the first member comprises an operation unit and the second member comprises a display panel.
